(19) United States
(12) Patent Application Publication
(10) Pub. No.: US 2022/0188938 A1
(43) Pub. Date: Jun. 16, 2022

(54) SYSTEMS AND METHODS OF GENERATING RECOMMENDATIONS FOR SECONDARY USERS OF A WELL-BEING APPLICATION

(71) Applicant: STATE FARM MUTUAL AUTOMOBILE INSURANCE COMPANY, Bloomington, IL (US)

(72) Inventors: Edward W. Breitweiser, Bloomington, IL (US); Jennifer L. Crawford, Normal, IL (US); Brian Steigerwald, Bloomington, IL (US); Danielle Malan, Downs, IL (US)

(21) Appl. No.: 17/550,473

(22) Filed: Dec. 14, 2021

Related U.S. Application Data
(60) Provisional application No. 63/126,121, filed on Dec. 16, 2020.

(51) Int. Cl. G06Q 40/08; G06Q 40/02; G06F 21/62; G06F 16/93

(52) U.S. Cl. CPC G06Q 40/08; G06F 16/93; G06F 21/6245; G06Q 40/025

(57) ABSTRACT

Systems and methods are disclosed relating to provisioning of a service to a secondary user of an application (app). Such systems and methods include establishing a primary user profile for a primary user of a well-being app, and identifying a secondary user. The primary user may be, for example, the owner of a life insurance policy, while the secondary user may be, for example, a beneficiary of the life insurance policy. The app may receive documents from both the primary user and the secondary user. In this regard, the app may facilitate convenient storage of documents related to the life insurance policy, and facilitate the transition of property from the primary user to the secondary user.

### CROSS-REFERENCE TO RELATED APPLICATIONS

This application claims the benefit of U.S. Provisional Application No. 63/126,121 (filed Dec. 16, 2020), the entirety of which is incorporated by reference herein.

### TECHNICAL FIELD

The present disclosure generally relates to systems and methods for provisioning of a service to a secondary user of an application.

### BACKGROUND

People often purchase life insurance policies to ensure that their loved ones or others are cared for upon their passing. However, when a person passes away, in addition to the life insurance policy document itself, there may be many other documents that are relevant to the beneficiaries of the life insurance policy. For instance, there may be documents for titles to properties, bank accounts, taxes, and so forth that are all relevant to the transition of property from the deceased to the beneficiary of the life insurance policy.

Yet, all too often, these documents are difficult to locate because they are stored in different locations, or because the deceased did not indicate to others (intentionally or unintentionally) where these documents were stored before she passed away. The techniques discussed herein address these problems and other drawbacks of conventional techniques.

### SUMMARY

The present embodiments relate to provisioning a service to a secondary user of an application (e.g., a beneficiary of a life insurance policy). Additional, fewer, or alternative features described herein below may be included in some aspects.

In one aspect, a computer-implemented method for provisioning of a service to a secondary user may be provided. The method may include, via one or more processors, (1) establishing a primary user profile associated with a primary user, the primary user profile including an insurance policy of the primary user; (2) identifying a secondary user based upon data of the primary user profile; (3) enrolling the secondary user in a secondary user account associated with the secondary user; and/or (4) provisioning a service to the secondary user based upon at least one of: (i) the data of the primary user profile, and/or (ii) an action of the primary user. The method may include additional, fewer, or alternate actions, including those discussed elsewhere herein.

In another aspect, a computer system for provisioning of a service to a secondary user may be provided. The system may include one or more processors configured to: (1) establish a primary user profile associated with a primary user, the primary user profile including an insurance policy of the primary user; (2) identify a secondary user based upon data of the primary user profile; (3) enroll the secondary user in a secondary user account associated with the secondary user; and/or (4) provision a service to the secondary user based upon at least one of: (i) the data of the primary user profile, and/or (ii) an action of the primary user. The system may include additional, less, or alternate functionality, including that discussed elsewhere herein.

In yet another aspect, another computer system for provisioning of a service to a secondary user may be provided. The system may include one or more processors. The system may further include a program memory coupled to the one or more processors and storing executable instructions that, when executed by the one or more processors, cause the computer system to: (1) establish a primary user profile associated with a primary user, the primary user profile including an insurance policy of the primary user; (2) identify a secondary user based upon data of the primary user profile; (3) enroll the secondary user in a secondary user account associated with the secondary user; and/or (4) provision a service to the secondary user based upon at least one of: (i) the data of the primary user profile, and/or (ii) an action of the primary user. The system may include additional, less, or alternate functionality, including that discussed elsewhere herein.

Systems or computer-readable media storing instructions for implementing all or part of the method described above may also be provided in some aspects. Systems for implementing such methods may include one or more of the following: client computing devices associated with users, a remote server, one or more communication modules configured to communicate wirelessly via radio links, radio frequency links, and/or wireless communication channels, and/or one or more program memories coupled to one or more processors of any such computing devices or servers. Such program memories may store instructions to cause the one or more processors to implement part or all of the method described above.

### BRIEF DESCRIPTION OF DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The Figures described below depict various aspects of the applications, methods, and systems disclosed herein. It should be understood that each Figure depicts an embodiment of a particular aspect of the disclosed applications, systems and methods, and that each of the Figures is intended to accord with one or more possible embodiments thereof. Furthermore, wherever possible, the following description refers to the reference numerals included in the following Figures, in which features depicted in multiple Figures are designated with consistent reference numerals.

FIG. 1 illustrates a block diagram of an exemplary well-being application system for monitoring and improving user well-being.

FIG. 2 illustrates a block diagram of an exemplary well-being application system including a second client device for a secondary user.

FIG. 3 illustrates a flow diagram of an exemplary well-being application method.

FIG. 4 illustrates a flow diagram of an exemplary well-being application method, including providing a list of documents to a primary user and/or a secondary user.

FIG. 5 illustrates a flow diagram of an exemplary well-being application method, including monitoring websites to determine that the primary user is deceased.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

A person's death may trigger many transactions that must occur in order to assure a smooth transfer of the decedent's property. For example, following a person's death, a beneficiary of a life insurance policy may be notified, and a life insurance claim may be submitted. As another example, potential inheritors may be informed of the decedent's assets and liabilities.

However, documents relevant to these transactions are often difficult to locate because they are stored in different locations, or because the decedent did not indicate to others where these documents were stored before she passed away, etc. It thus is useful to collect, in one central location, many of the documents that will aid in the transactions that follow a person's death. In this regard, it may be useful to provide applications (apps) for one or both of a primary user (e.g., an owner of a life insurance policy), and/or a secondary user(s) (e.g., a beneficiary of the life insurance policy).

More broadly, the app(s) provided to the primary and/or secondary user(s) may be part of a well-being app(s). That is, app(s) that not only addresses the problems discussed above, but also that enhance a user's well-being related to physical health, mental health, financial condition, document organization, social connection, community involvement, or other aspects of well-being.

### Exemplary Well-Being Application System

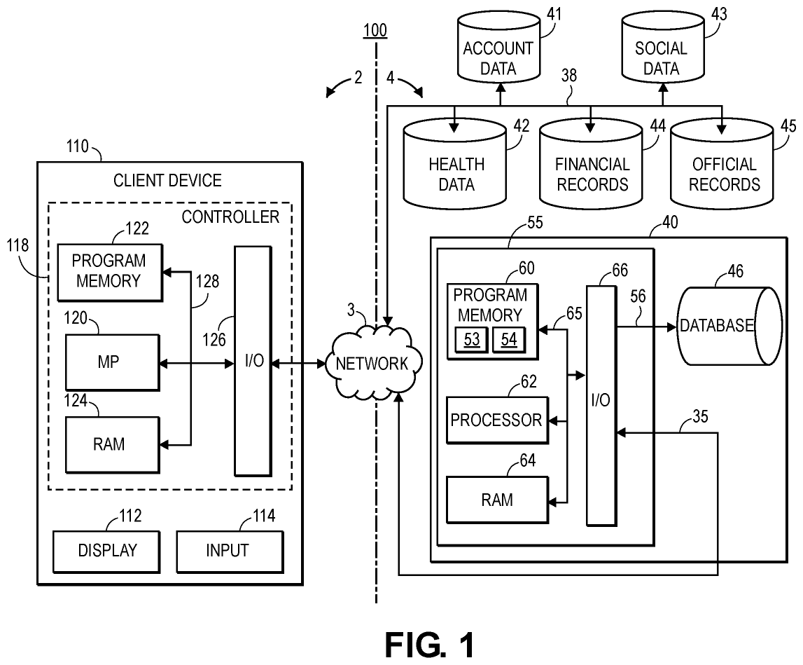

FIG. 1 illustrates a block diagram of an exemplary well-being application system 100 on which the exemplary computer-based methods described herein may be implemented to monitor and improve user well-being. The high-level architecture may include both hardware and software applications, as well as various data communications channels for communicating data between the various hardware and software components. The well-being application system 100 may be roughly divided into front-end components 2 and back-end components 4. The front-end components 2 may be associated with users of a well-being application to monitor, manage, and/or enhance their well-being related to physical health, mental health, financial condition, document organization, social connection, community involvement, or other aspects of well-being. The back-end components 4 may include hardware and software components implementing aspects of such well-being applications, as well as internal or external data sources associated with user well-being data.

In some embodiments of the system 100, the front-end components 2 may communicate with the back-end components 4 via a network 3. One or more client devices 110 associated with users of the well-being application(s) may communicate with the back-end components 4 via the network 3 to receive data from and provide data to back-end components 4 associated with the well-being application(s). The back-end components 4 may use one or more servers 40 to receive data and data requests from the front-end components 2, process and store received data, access additional data sources, analyze user well-being, provide data to the front-end components 2, and/or perform additional well-being application functions as described herein. The one or more servers 40 may also communicate with other back-end components 4, such as additional data sources 41-45. Some embodiments may include fewer, additional, or alternative components.

The front-end components 2 may be disposed within one or more client devices 110, which may include a desktop computer, notebook computer, netbook computer, tablet computer, or mobile device (e.g., a cellular telephone, smart phone, wearable computer, smart speaker, smart appliance, IoT device, etc.). The client device 110 may include a display 112, an input 114, and a controller 118. In some embodiments, the client device 110 may further include a Global Positioning System (GPS) unit (not shown) to determine a geographical location of the client device 110. The input 114 may include a “soft” keyboard that is displayed on the display 112 of the client device 110, an external hardware keyboard communicating via a wired or a wireless connection (e.g., a Bluetooth keyboard), an external mouse, or any other suitable user-input device. The input 114 may further include a microphone, camera, or other input device capable of receiving information. The controller 118 includes one or more microcontrollers or microprocessors (MP) 120, a program memory 122, a RAM 124, and an I/O circuit 126, all of which may be interconnected via an address/data bus 128. The program memory 122 may include an operating system, a data storage, a plurality of software applications, and/or a plurality of software routines.

The program memory 122 may include software applications, routines, or scripts for implementing communications between the client device 110 and the server 40 or additional data sources 41-45 via the network 3. For example, the program memory 122 may include a web browser program or application, thereby enabling the user to access web sites via the network 3. As another example, the program memory 122 may include a social media application that receives data from and sends data to a social data source 43 via the network 3. The program memory 122 may further store computer-readable instructions for a program or application associated with one or more well-being applications.

In some embodiments, the controller 118 may also include, or otherwise be communicatively connected to, other data storage mechanisms (e.g., one or more hard disk drives, optical storage drives, solid state storage devices, etc.) that reside within the client device 110. It should be appreciated that although FIG. 1 depicts only one microprocessor 120, the controller 118 may include multiple microprocessors 120. Similarly, the memory of the controller 118 may include multiple program memories 122 or multiple RAMs 124. Although the FIG. 1 depicts the I/O circuit 126 as a single block, the I/O circuit 126 may include a number of different types of I/O circuits. The controller 118 may implement the program memories 122 or the RAMs 124 as semiconductor memories, magnetically readable memories, or optically readable memories, for example.

The various computing devices of the front-end components 2 may communicate with the back-end components 4 via wired or wireless connections to the network 3. The network 3 may be a proprietary network, a secure public internet, a virtual private network or some other type of network, such as dedicated access lines, plain ordinary telephone lines, satellite links, cellular data networks, combinations of these. The network 3 may include one or more radio frequency communication links, such as wireless communication links with client devices 110. The network 3 may also include other wired or wireless communication links with other client devices 110 or other computing devices. Where the network 3 may include the Internet, and data communications may take place over the network 3 via an Internet communication protocol.

The back-end components 4 may include one or more servers 40 configured to implement part or all of the processes related to the well-being application(s) described herein. Each server 40 may include one or more computer processors adapted and configured to execute various software applications and components of the well-being application system 100, in addition to other software applications. The server 40 may further include a database 46, which may be adapted to store data related to user well-being for a plurality of users and/or data relating to recommendations or incentives for users. Such data may include data related to user preferences, user conditions, user policies or accounts, user property, user actions, user incentives, user goals, goal progress, user biometric data, or other well-being data relating to a user, as discussed elsewhere herein, part or all of which data may be collected by or uploaded to the server 40 via the network 3. The server 40 may access data stored in the database 46 or external data sources when executing various functions and tasks associated with the methods discussed elsewhere herein.

The server 40 may have a controller 55 that is operatively connected to the database 46 via a link 56. It should be noted that, while not shown, additional databases may be linked to the controller 55 in a known manner. For example, separate databases may be used for various types of information, such as user profiles, user activity data, or well-being data models. Additional data sources 41-45 may be communicatively connected to the server 40 via the network 3, such as databases maintained by third parties or databases associated with other servers 40. The controller 55 may include a program memory 60, a processor 62 (which may be called a microcontroller or a microprocessor), a random-access memory (RAM) 64, and an input/output (I/O) circuit 66, all of which may be interconnected via an address/data bus 65.

It should be appreciated that although only one processor 62 is shown, the controller 55 may include multiple processors 62. Similarly, the memory of the controller 55 may include multiple RAMs 64 and multiple program memories 60. Although the I/O circuit 66 is shown as a single block, it should be appreciated that the I/O circuit 66 may include a number of different types of I/O circuits. The RAM 64 and program memories 60 may be implemented as semiconductor memories, magnetically readable memories, or optically readable memories, for example. The controller 55 may also be operatively connected to the network 3 via a link 35.

The server 40 may further include a number of software applications stored in a program memory 60. The various software applications on the server 40 may include one or more software applications for monitoring, storing, evaluating, generating, and tracking user well-being data or recommendations. Such software applications may include a well-being evaluation module 53 configured to generate user well-being metrics or identify user well-being conditions, as well as artificial intelligence models 54 trained and used for generating user well-being recommendations, as discussed further below. The various software applications may be executed on the same computer processor or on different computer processors.

The back-end components 4 may further include one or more additional data sources 41-45 providing information relating to aspects of user well-being. These additional data sources 41-45 may be configured to communicate with the server 40 through the network 3 via a link 38. The additional data sources 41-45 may include an account data source 41, a health data source 42, a social data source 43, a financial records data source 44, and/or an official records data source 45. Information regarding various aspects of users' physical, mental, social, or financial health may be stored in databases associated with the various additional data sources 41-45, which data may be accessed as part of the methods described herein. In some embodiments, additional or alternative data sources may be accessed to obtain further information relevant to user well-being.

The account data source 41 may maintain user account data for a plurality of user accounts associated with users of client devices 110. In some embodiments, such user account data may include user profiles for such users, which may be associated with various services, such as telecommunications services, financial services, insurance policies, or well-being services. For example, user account data may include information regarding insurance policies, bank accounts, and investment accounts associated with a user.

The health data source 42 may maintain user health data associated with a plurality of users, such as biometrics data from wearable computing devices or electronic medical records. Such user health data may be used to monitor aspects of user physical and mental health. In some embodiments, the user health data may relate to individuals associated with a user of a well-being application, such as young children or elderly parents of the user.

The social data source 43 may maintain user social data associated with a plurality of users, such as users of social media platforms. Such social data may be used to identify life events based upon user profile information updates, user posts, or posts referencing a user. In some embodiments, user posts or metadata regarding user posts may also be analyzed to determine user social connections or mental well-being (e.g., stress levels, connectedness, depression, loss, etc.), which may include performing user sentiment analysis.

The financial records data source 44 may maintain user financial records, such as banking or investment records. In some embodiments, financial records may include credit-related records maintained by credit rating agencies, such as revolving accounts, loans, assets, or contractual agreements (e.g., leases, utility, or other services). Such financial records may be used to determine user financial well-being or to generate recommendations regarding improvements in the user's current financial condition or planning for future events (e.g., collecting, organizing, or reviewing financial documents).

The official records data source 45 may maintain official records regarding a user, such as records maintained by various governmental agencies. Such official records may include user property records, licensure records, birth/death records, benefits records, or other official records associated with a user's well-being. In some embodiments, official records may include notices published in newspapers of records or other reliable non-governmental sources.

Although the well-being application system 100 is shown to include one or a limited number of the various front-end components 2 and of the back-end components 4, it should be understood that different numbers of any or each of these components may be utilized in various embodiments. Furthermore, the database storage or processing performed by the one or more servers 40 and/or additional data sources 41-45 may be distributed among a plurality of components in an arrangement known as “cloud computing.” This configuration may provide various advantages, such as enabling near real-time uploads and downloads of information, as well as providing additional computing resources needed to handle the monitoring, modeling, evaluation, and/or recommendation tasks described herein. This may in turn support a thin-client embodiment of some computing devices of the front-end components 2, such as some client devices 110.

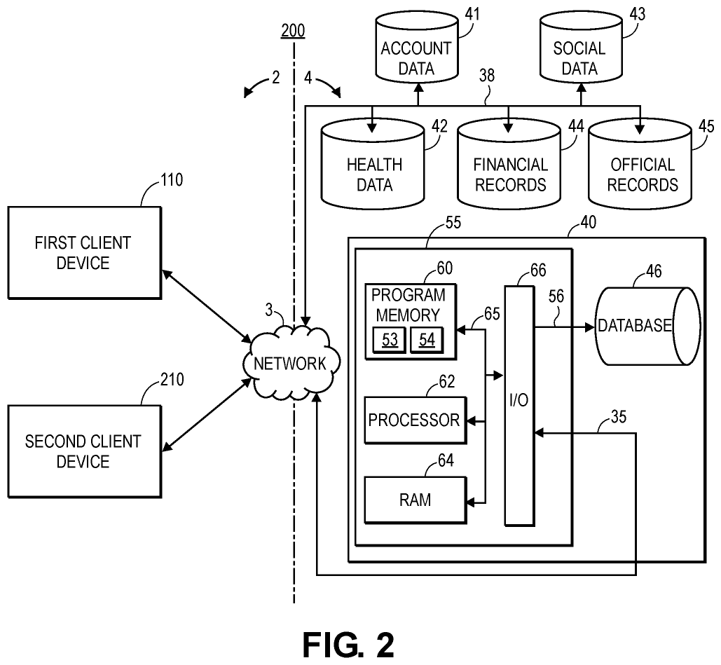

FIG. 2 illustrates a block diagram of an exemplary well-being application system 200 on which the exemplary computer-based methods described herein may be implemented to monitor and improve user well-being. In addition to the first client device 110 (as discussed above with respect to FIG. 1), the example of FIG. 2 includes a second client device 210. In some embodiments, the second client device 210 has the same type of internal components as the first client device 110; and thus, the discussion above with respect to the client device 110 in FIG. 1 applies analogously to the second client device.

In some embodiments, the first client device 110 is used by a primary user of an app (e.g., the owner of a life or disability insurance policy), while the second client device 210 is used by a secondary user of an app (e.g., a beneficiary of a life insurance policy, an executor, an estate planning attorney, and/or a financial advisor, etc.). In this regard, and as will be discussed further below, the secondary user may provide, have knowledge of, and/or access documents relevant to the passing of the primary user.

### Exemplary Methods For Provisions of a Service to a Secondary User

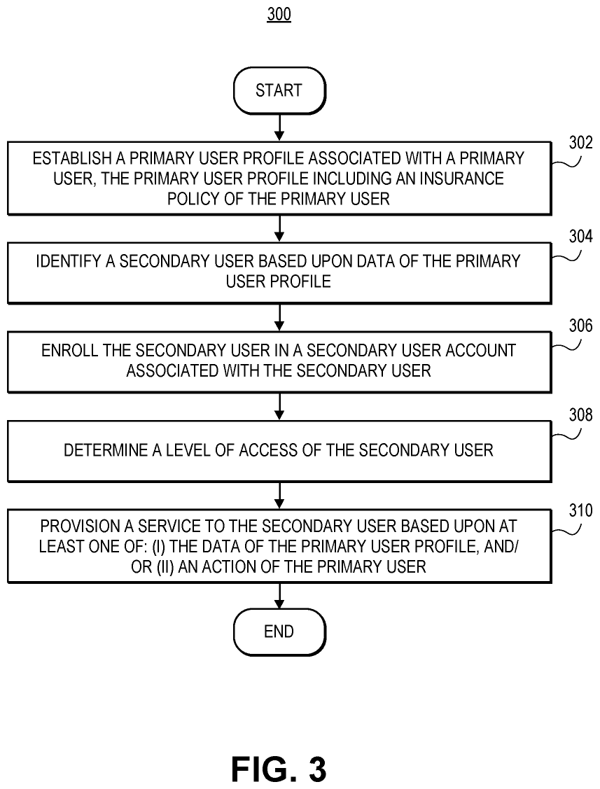

FIGS. 3-5 illustrate exemplary methods in accordance with the techniques discussed herein. The well-being application methods 300, 400, 500 are exemplary only, and other methods may include additional, fewer, or alternative actions. Various parts of the well-being application methods 300, 400, 500 may be implemented by or performed using the various front-end components 2 and back-end components 4, which may communicate via the network 3, as described above. In some embodiments, the well-being application methods 300, 400, 500 may be implemented by one or more servers operating as a cloud services network (e.g., one or more servers 40 configured to implement a single well-being application platform).

As should be understood, the techniques discussed herein may be implemented as a single app (e.g., running on both the first client device 110, and the second client device 210). Alternatively, the techniques may be implemented by invoking multiple different apps (e.g., the techniques are performed in part by an app running on the first client device 110, and in part by a second app running on the second client device 210). In another alternative, the techniques may be performed by any number of different components discussed with respect to, or shown in, FIGS. 1 and 2.

FIG. 3 illustrates a flow diagram of an exemplary well-being application method 300, which, in some embodiments, provisions a service to a secondary user. At block 302, the well-being application method 300 may begin by establishing a primary user profile associated with a primary user, the primary user profile including an insurance policy of the primary user. The primary user profile may further include any additional information, such as additional information about the primary user. For example, the primary user profile may include the primary user's personal information, such as the primary user's name, social security number, mailing address, residential address, work address, email address, phone number, marital status, birthday, and/or gender, etc.

The primary user profile may also include other information, such as additional insurance information. For instance, the primary user profile may include additional insurance policies. For example, the primary user profile may list a life insurance policy, a disability insurance policy, an auto insurance policy, and/or a home insurance policy, etc. In this regard, it should be understood that the insurance policies themselves (e.g., the text of the documents) may be stored; alternatively, only the titles of the insurance policies may be stored (but not, e.g., the text of the documents).

The primary user profile may further include documents and/or a list of documents relevant to transactions that will occur following the primary users death. For instance, the primary user profile may include any of the insurance policies mentioned above, as well as a property title, a car title, a will, a trust, a tax record, a stock, and/or a bank account, etc. Storing these documents in a single location (e.g., the primary user profile) is helpful to ensure that they are available to relevant parties following a death of the primary user.

At block 304, the server 40 may identify a secondary user based upon data of the primary user profile. For example, the data of the primary user profile may indicate a beneficiary or beneficiaries of a life insurance policy, and thus the secondary user(s) may be identified to be the beneficiary or beneficiaries of the life insurance policies. In another example, the data of the user profile may directly indicate a secondary user. For instance, the primary user may be prompted to directly enter/indicate a secondary user. In yet another example, the secondary user may be identified to be an estate planning attorney, a financial advisor and/or an executor of an estate of the primary user.

In other examples, the primary user may indicate that any beneficiaries of a life insurance policy set to receive a percentage of the life insurance proceeds above a predetermined percentage should be identified as secondary users. In another example, the primary user may indicate that primary beneficiaries (but not secondary beneficiaries) of a life insurance policy are to be identified as secondary users.

At block 306, the server 40 may enroll the secondary user in a secondary user account associated with the secondary user. The secondary account may be part of the app used by the primary user, or it may be part of a separate app for the secondary user. The secondary account may assist the secondary user with any number of tasks, and may later provision a service to the secondary user.

In any event, upon enrollment, in some embodiments, the secondary user account is created based upon information from the primary user account. For example, insurance policy information from the primary user account may be imported to the secondary user account. For instance, this may allow the secondary user to view the text of the primary user's life insurance policy.

Furthermore, the secondary user account may include any information regarding the primary user and/or the secondary user. For example, the secondary user account may include any information for the secondary user that was included in the profile of the primary user for the primary user. In this regard, this information may include the secondary user's personal information, such as the secondary user's name, social security number, mailing address, residential address, work address, email address, phone number, marital status, birthday, and/or gender, etc. In some embodiments, the personal information of the primary user is included in the secondary user's account as well.

At block 308, the server 40 may determine a level of access of the secondary user. The level of access may be determined based upon an indication received from the primary user. Additionally or alternatively, the level of access may be determined by the data in the primary user profile. For example, the primary user may indicate that any beneficiaries of a life insurance policy set to receive a percentage of the life insurance proceeds above a predetermined percentage should be granted a particular level of access. In another example, the primary user may indicate that primary beneficiaries of a life insurance policy are granted a certain level of access; whereas, secondary beneficiaries of a life insurance policy are granted another level of access.

At block 310, the server 40 may provision a service to the secondary user based upon at least one of: (i) the data of the primary user profile, and/or (ii) an action of the primary user. In some embodiments, this comprises providing the secondary user access to information of the primary user profile by displaying, to the secondary user, on an electronic interface, the information of the primary user profile. In some implementations, the information of the primary user profile displayed to the secondary user includes the type of the insurance policy; and/or a name of at least one document of the primary user profile.

The service may be provisioned to the secondary user via a distinct process or user interface from that used to provision services to the primary users. Thus, a secondary-user interface may be presented to the secondary user to provide limited, alternative, or additional functionality. The functionality provided to the secondary user may include information or recommendations relating to the primary user and, in some embodiments, additional information or functionality for the secondary user. For example, where the secondary user is a beneficiary of an insurance policy associated with the primary user, the secondary-user interface may include functionality relating to services that may be of particular relevance to beneficiaries. In some embodiments, the provisioning of a service to the secondary user allows the user to upload documents (e.g., to server 40). Advantageously, this allows for storage of the documents in one central location.

In some embodiments, the secondary user is allowed to upload documents only after the primary user is given an opportunity to do so. For instance, the server 40 may request to the primary user, that the primary user provide at least one document; and if the primary user does not provide the at least one document, the server 40 may request, to the secondary user, that the secondary user provide the at least one document.

In some implementations, the server 40 may provision a service to the secondary user based upon the level of access determined at block 308. For example, some embodiments involve four possible levels of access: (1) a first level of access including that the secondary user is allowed to view information of the primary user profile only when a triggering event occurs; (2) a second level of access including that the secondary user is allowed to view names of documents associated with the primary user profile, but the secondary user is not allowed to view document contents of the documents associated with the primary user profile; (3) a third level of access including that the secondary user is allowed to view both the names of the documents associated with the primary user profile and the document contents of the documents associated with the primary user profile; and (4) a fourth level of access including full access to the information of the primary user profile.

In some embodiments, the provisioning of a service to the secondary user is based upon an action of the primary user (e.g., an in-app action of the primary user). For example, if the primary user uses a well-being app to check a stock, the secondary user (e.g., a financial planner or estate planning attorney) may be prompted to enter information of the stock, and/or confirm that the primary user owns the stock, etc.

In some embodiments, the server 40 uses social data 43 to provision the service to the secondary user. For example, the server 40 may analyze the social data 43 to determine documents that the secondary user should be prompted to upload.

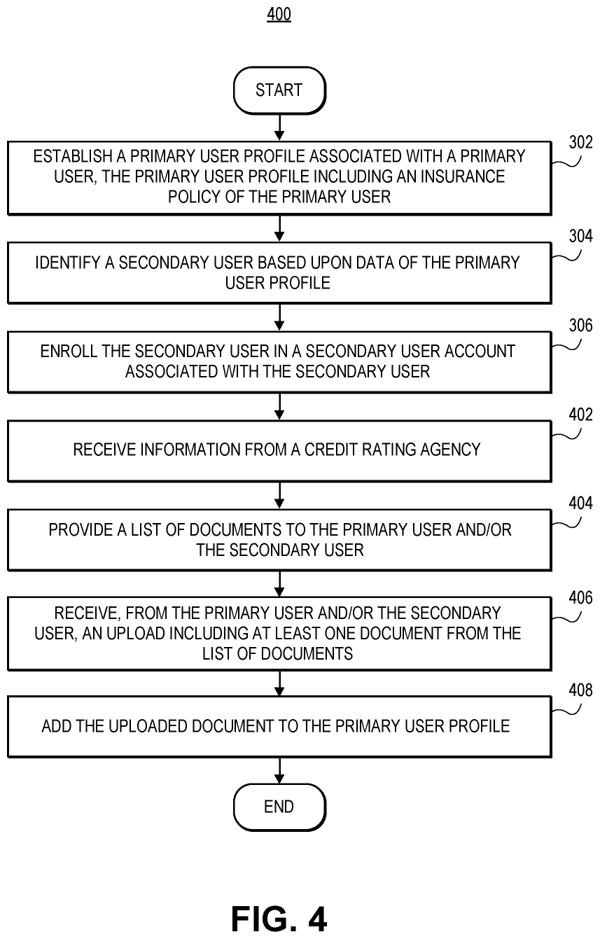

FIG. 4 illustrates a flow diagram of an exemplary well-being application method 400, including providing a list of documents to a primary user and/or a secondary user. With reference thereto, in some embodiments, blocks 302, 304, and 306 are similar to blocks 302, 304, and 306 of FIG. 3.

At block 402, the server 40 may receive information from a credit rating agency (e.g., from the financial records database 44 where the financial records database 44 comprises a credit rating agency). The information sent from the credit rating agency may include any information, such as information of the primary users assets (e.g., bank accounts, properties, other assets, liabilities, etc.). In this regard, the information sent from the credit rating agency may be used by the server 40 to determine documents that are relevant to transactions that must occur upon the primary user's passing (e.g., the list of block 404).

At block 404, the server 40 may provide, to both the primary user and the secondary user, a list of documents. In some embodiments, the list of documents includes any or all of: property title, a car title, a will, a trust, a tax record, a stock, and/or a bank account, etc. The list of documents may be determined by any suitable technique. For example, the list may be determined, at least in part, based upon the information received from the credit rating agency at block 402. In another example, the primary user is sent a questionnaire to fill out, and the primary user's answers to the questionnaire are used to determine the list of documents; for instance, the questionnaire may ask the primary user to specify bank accounts, property, etc. In yet another example, the list sent to the primary and secondary user may be a default list of documents.

At block 406, the server 40 may receive, from either the primary user or the secondary user, an upload including at least one document from the list of documents. The documents may be uploaded in any suitable format. For example, the user may upload a tax return document in a .pdf format. In another example, the user may take a picture (e.g., using a camera attached to the client device 110) of a document, and upload the picture.

At block 408, the server 40 may add the uploaded document to the primary user profile. Advantageously, this allows for central storage of the documents, as well as for optimal access to the documents upon passing of the primary user. In some embodiments, once the document is uploaded to the primary user profile, both the primary and secondary users are able to download the document. In other embodiments, whether the secondary user is able to download the document depends on a level of access granted to the secondary user.

In addition, in some embodiments, secondary user(s) may be replaced with other secondary user(s). For example, a primary user may initially assign her sibling to be a first secondary user. Subsequently, the primary user may replace the sibling with her new spouse (e.g., a second secondary user). In this regard, in some embodiments, when the first secondary user is replaced with the second secondary user, data of the first secondary user may be retained in the primary user account, but the first secondary user may be given a status of “terminated.” The primary user account may also show an end date of the first secondary user's status as a secondary user. In some embodiments, the first secondary user is presented with an option to delete their data from the database upon being removed as a secondary user. In some embodiments, the first secondary user's data is automatically deleted (e.g., from the database 46) upon removal of the first secondary user.

Furthermore, any kind of secondary user (e.g., any of a beneficiary, estate planning attorney, a financial advisor and/or an executor of an estate of the primary user) may be replaced by another secondary user.

In some embodiments, the secondary user may also have their own primary user account (e.g., of their own insurance policies). In these situations, when a first secondary user is replaced by a second secondary user, the prior status of the first secondary user may be achieved (e.g., stored and/or displayed) in the primary user account of the first secondary user. For example, there may be two spouses who are policyholders (e.g., two primary users each with their own primary user accounts) naming each other as beneficiaries. Following divorce, each (former) spouse may wish to reassign their beneficiary, and revoke the other (former) spouse's access to the account. Data, in some embodiments, is retained on each primary account with an end date, status of “terminated.” In some embodiments, an option is sent to one or both of the secondary user(s) who have had their status as a beneficiary revoked which allows the secondary user to delete their records from the primary user's account. In some embodiments, no option to delete records is presented, and/or records are deleted automatically upon termination of the secondary user's status as a beneficiary.

In some scenarios, the secondary user may pass away before the primary user. Here, in some implementations, if the server 40 determines that the secondary user has passed away, the server 40 may send a notification to the primary user that the secondary user has passed away, and/or notify the primary user to select another secondary user (e.g., as a new beneficiary, etc.). In this regard, the server 40 may user any suitable method to determine that the secondary user has passed away. For example, the system 40 may use list of identities from insurance records (e.g., in database 46), obituaries, and/or credit reports (e.g., in financial records database 44), etc. If a report requested by the server 40 returns a value of “deceased” for the secondary user, the secondary user account may be updated with the “deceased” status, and/or a notification sent to the primary user to review and take action on their account (e.g., to designate a new secondary user, such as a new beneficiary). Furthermore, in some embodiments, when a secondary user status is “deceased” and that identity has no active primary account or other secondary account status, the server 40 may remove the user from the list of identities that the system scans.

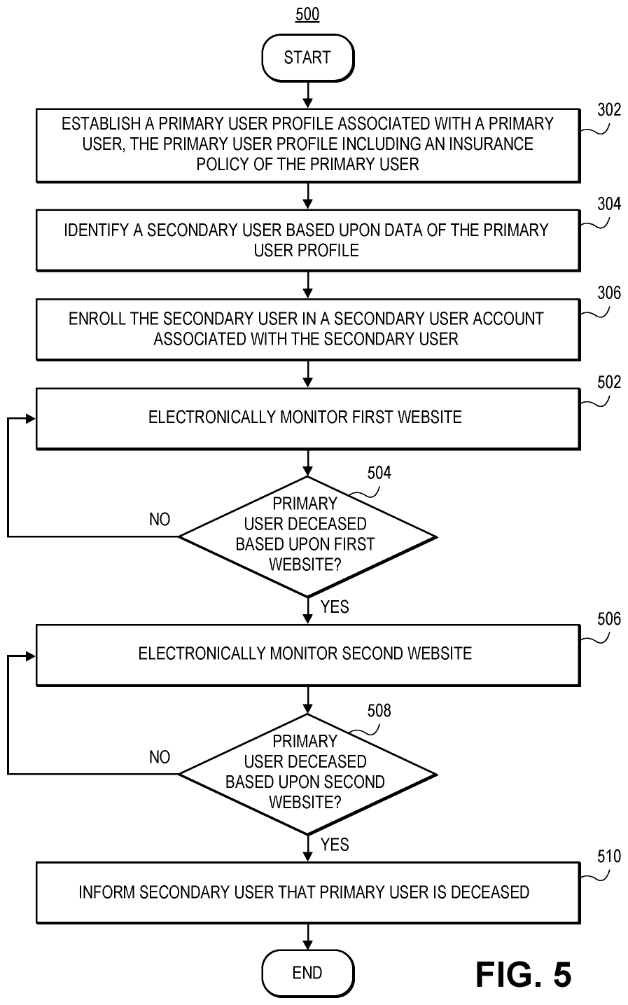

FIG. 5 illustrates a flow diagram of an exemplary well-being application method 500, including monitoring websites to determine that the primary user is deceased. With reference thereto, in some embodiments, blocks 302, 304, and 306 are similar to blocks 302, 304, and 306 of FIG. 3.

At block 502, the server 40 electronically monitors a first website. This may be done by any suitable technique. For example, the text of the first website may be analyzed with a natural language processing (NLP) engine. For instance, the first website may publish an obituary, and the NLP engine may determine that the obituary indicates that the primary user has passed away.

At block 504, the server 40 determines (e.g., by processing information from the obituary) if the first website indicates that the primary user is deceased. If not, the exemplary method returns to block 502, and the server 40 continues to electronically monitor the first website.

If the first website indicates that the primary user is deceased, the server 40 proceeds to electronically monitor a second website (block 506). As with the monitoring of the first website, the monitoring of the second website may also be done by any suitable technique. For example, the text of the second website may be analyzed with a NLP engine. For instance, the second website may publish an obituary, and the NLP engine may determine that the obituary indicates that the primary user has passed away.

In some embodiments, the second website has no connection with the first website (e.g., the websites are from different newspapers). In this regard, as will become clear from the discussion below, the purpose of monitoring the second website is to verify that the determination from the first website that the user is deceased is correct.

At block 508, the server 40 determines if the second website indicates that the primary user is deceased. In this way, the monitoring of the second website is done to verify that the determination from the first website was correct. In this regard, in some embodiments, the secondary user is not immediately informed of the determination from the first website that the primary user has passed away. Rather, the system informs the secondary user only after the verification (e.g., block 510), and the secondary user is thus better protected against being informed based upon a false positive determination that the primary user has passed away.

If the determination at block 508 is no, the exemplary method returns to block 506, and the server 40 continues to electronically monitor the second website. If the determination at block 508 is yes, at block 510, the secondary user is informed that the primary user has passed away. In some embodiments, at block 510, the server 40 also automatically submits a life insurance claim on behalf of the secondary user.

As this illustrates, the monitoring of the second website advantageously provides a verification that primary user has passed away before sending a notification to the secondary user.

### Other Matters

Although the preceding text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. For example, a module may comprise dedicated circuitry or logic that is permanently configured (e.g., as a special-purpose processor, such as a field programmable gate array (FPGA) or an application-specific integrated circuit (ASIC) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in dedicated and permanently configured circuitry, or in temporarily configured circuitry (e.g., configured by software) may be driven by cost and time considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules can provide information to, and receive information from, other modules. Accordingly, the described modules may be regarded as being communicatively coupled. Where multiple such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the one or more processors or processor-implemented modules may be located in a single geographic location (e.g., at a location of a mobile computing device or at a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Such memories may be or may include non-transitory, tangible computer-readable media configured to store computer-readable instructions that may be executed by one or more processors of one or more computer systems.

As used herein any reference to “one embodiment” or “an embodiment” means that a particular element, feature, structure, or characteristic described in connection with the embodiment is included in at least one embodiment. The appearances of the phrases “in one embodiment,” “in an embodiment,” “in some embodiments,” or similar phrases in various places in the specification are not necessarily all referring to the same embodiment or the same set of embodiments.

Some embodiments may be described using the terms “coupled,” “connected,” “communicatively connected,” or “communicatively coupled,” along with their derivatives. These terms may refer to a direct physical connection or to an indirect (physical or communicative) connection. For example, some embodiments may be described using the term “coupled” to indicate that two or more elements are in direct physical or electrical contact. The term “coupled,” however, may also mean that two or more elements are not in direct contact with each other, but yet still co-operate or interact with each other. Unless expressly stated or required by the context of their use, the embodiments are not limited to direct connection.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless the context clearly indicates otherwise.

This detailed description is to be construed as exemplary only and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for the systems and a methods disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

Finally, the patent claims at the end of this patent application are not intended to be construed under 35 U.S.C. § 112(f), unless traditional means-plus-function language is expressly recited, such as “means for” or “step for” language being explicitly recited in the claims. The systems and methods described herein are directed to an improvement to computer functionality, which may include improving the functioning of conventional computers in performing tasks.

What is claimed is:

1. A computer-implemented method for provisioning of a service to a secondary user, the method comprising, via one or more processors:
establishing a primary user profile associated with a primary user, the primary user profile including an insurance policy of the primary user;
identifying a secondary user based upon data of the primary user profile;
enrolling the secondary user in a secondary user account associated with the secondary user; and
provisioning a service to the secondary user based upon at least one of: (i) the data of the primary user profile, and/or (ii) an action of the primary user.

2. The computer-implemented method of claim 1, wherein:
the data of the primary user profile indicates that the secondary user is a beneficiary of the insurance policy; and
the identification of the secondary user is based upon the indication that the secondary user is the beneficiary of the insurance policy.

3. The computer-implemented method of claim 1, further comprising:
providing, to both the primary user and the secondary user, a list of documents;
receiving, from either the primary user or the secondary user, an upload including at least one document from the list of documents; and
adding the uploaded document to the primary user profile.

4. The computer-implemented method of claim 3, wherein the list of documents is created based upon information received from a credit rating agency.

5. The computer-implemented method of claim 1, wherein:
the provisioning of the service to the secondary user comprises providing the secondary user access to information of the primary user profile by displaying, to the secondary user, on an electronic interface, the information of the primary user profile.

6. The computer-implemented method of claim 5, wherein the information of the primary user profile displayed to the secondary user includes at least one of:
a type of the insurance policy; and/or
a name of at least one document of the primary user profile.

7. The computer-implemented method of claim 6, wherein:
the type of the insurance policy is a life insurance policy; and/or
the name of the at least one document is associated with:
a property title;
a car title;
a will;
a trust;
a tax record;
a stock; and/or
a bank account.

8. The computer-implemented method of claim 1, further comprising:
requesting, to the primary user, that the primary user provide at least one document; and
if the primary user does not provide the at least one document, requesting, to the secondary user, that the secondary user provide the at least one document.

9. The computer-implemented method of claim 1, further comprising determining a level of access of the secondary user, the level of access being one of:
a first level of access indicating that the secondary user is allowed to view information of the primary user profile only when a triggering event occurs;
a second level of access indicating that the secondary user is allowed to view names of documents associated with the primary user profile, but the secondary user is not allowed to view document contents of the documents associated with the primary user profile;
a third level of access indicating that the secondary user is allowed to view both the names of the documents associated with the primary user profile and the document contents of the documents associated with the primary user profile; and
a fourth level of access including full access to the information of the primary user profile.

10. The computer-implemented method of claim 1, wherein the data of the primary user profile indicates that the secondary user is an estate planning attorney, a financial advisor and/or an executor of an estate of the primary user.

11. The computer-implemented method of claim 1, wherein:
the insurance policy is a life insurance policy, and the secondary user is a beneficiary of the life insurance policy; and
the method further comprises:
electronically monitoring a first website, and based upon the electronic monitoring of the first website, determining that the primary user is deceased;
electronically monitoring a second website, and based upon the electronic monitoring of the second website, verifying the determination that the primary user is deceased; and
in response to the verification that the primary user is deceased, informing the secondary user that the primary user is deceased.

12. A non-transitory computer-readable storage medium for provisioning of a service to a secondary user, the non-transitory computer-readable storage medium comprising instructions that, when executed, cause a processor to:
establish a primary user profile associated with a primary user, the primary user profile including an insurance policy of the primary user;
identify a secondary user based upon data of the primary user profile;
enroll the secondary user in a secondary user account associated with the secondary user; and
provision a service to the secondary user based upon at least one of: (i) the data of the primary user profile, and/or (ii) an action of the primary user.

13. The non-transitory computer-readable storage medium of claim 12, wherein:
the data of the primary user profile indicates that the secondary user is a beneficiary of the insurance policy; and
the identification of the secondary user is based upon the indication that the secondary user is the beneficiary of the insurance policy.

14. The non-transitory computer-readable storage medium of claim 12, wherein the instructions, when executed, further cause the processor to:
provide, to both the primary user and the secondary user, a list of documents;
receive, from either the primary user or the secondary user, an upload including at least one document from the list of documents; and
add the uploaded document to the primary user profile.

15. The non-transitory computer-readable storage medium of claim 14, wherein the list of documents is created based upon information received from a credit rating agency.

16. The non-transitory computer-readable storage medium of claim 12, wherein:
the provision of the service to the secondary user comprises providing the secondary user access to information of the primary user profile by displaying, to the secondary user, on an electronic interface, the information of the primary user profile.

17. A computer system for provisioning of a service to a secondary user, the computer system comprising:
one or more processors; and
a program memory coupled to the one or more processors and storing executable instructions that, when executed by the one or more processors, cause the computer system to:
establish a primary user profile associated with a primary user, the primary user profile including an insurance policy of the primary user;
identify a secondary user based upon data of the primary user profile;
enroll the secondary user in a secondary user account associated with the secondary user; and
provision a service to the secondary user based upon at least one of: (i) the data of the primary user profile, and/or (ii) an action of the primary user.

18. The computer system of claim 17, wherein:
the secondary user is a first secondary user, and the secondary user account is a first secondary user account; and
the executable instructions further cause the computer system to:
identify a second secondary user based upon the data of the primary user profile;
delete the first secondary user account;
enroll the second secondary user in a second secondary user account associated with the secondary user; and
provision a service to the second secondary user based upon at least one of: (i) the data of the primary user profile, and/or (ii) an action of the primary user.

19. The computer system of claim 18, wherein the executable instructions further cause the computer system to:
if the first secondary user has their own primary user account, indicate a status of the first secondary user as a prior secondary user in the primary user account of the first secondary user.

20. The computer system of claim 17, wherein the executable instructions further cause the computer system to:
determine if the secondary user has passed away; and
if the secondary user has passed away, notify the primary user to select another secondary user.
